(19) United States
(12) Patent Application Publication
(10) Pub. No.: US 2007/0199038 A1
(43) Pub. Date: Aug. 23, 2007

(54) System and method for providing personal broacast recording channel service using extensible markup language

(76) Inventor: Jung-In Choi, Seoul (KR)

Correspondence Address: INTELLECTUAL PROPERTY LAW GROUP LLP, 12 SOUTH FIRST STREET, SUITE 1205, SAN JOSE, CA, 95113, US

(21) Appl. No.: 10/599,137

(22) PCT Filed: Sep. 22, 2004
(86) PCT No.: PCT/KR04/02429

§ 371 Date: Sep. 20, 2006

(30) Foreign Application Priority Data
Mar. 22, 2004 (KR) 10-2004-0019496
Mar. 22, 2004 (KR) 10-2004-0019497
May 4, 2004 (KR) 10-2004-0031260

(51) Int. Cl. H04N 7/16; H04N 7/173

(52) U.S. Cl. 725/134; 725/142; 725/135; 725/133

(57) ABSTRACT

Disclosed herein is a system and method for providing personal broadcast recording channel service using extensible Markup Language (XML). The system includes a user interface, an interface server and a wizard/transmission server. The system and the method allow members to conveniently instruct the members' remote Personal Video Recorders (PVRs) to record broadcasts using Personal Computers (PC) or wired/wireless communication terminals and a common network.

### TECHNICAL FIELD

The present invention relates, in general, to remote control service for home appliances and, more particularly, to a system and method for providing personal broadcast recording channel service using extensible Markup Language, which allow general television broadcast programs, and wired/cable/satellite/high-quality digital broadcast content to be conveniently recorded using the personal video recorders of service members at remote locations through wired/wireless communication devices, such as personal computer terminals, general telephones, mobile phones, and personal digital assistants, to which the Internet is available, and a common network.

### BACKGROUND ART

Recently, the number of channels of general TeleVision (TV), wired, cable, and satellite broadcasting as well as digital broadcasting have increased to several hundred channels.

In these conditions, it is almost impossible for a viewer to watch TV or search for desired broadcast programs while changing channels by manipulating a remote controller or using the keys or buttons of the TV. In addition, it is also difficult and inconvenient to record a broadcast program at a time desired by the viewer.

As a method for overcoming the inconvenience, technologies, such as an Electronic Program Guide (EPG), and an Interactive TV Program Guide (IPG), have been proposed to increase viewers' convenience.

The EPG assumes a guide role to help viewers watch TV in the era of multiple channels and multiple media using an electronically processed TV program guide.

That is, when EPG is compared with Internet surfing and an Internet portal site for the Internet surfing, the EPG allows a TV program portal site to be displayed on any one of a viewer's TV channels, and the TV program portal site itself is complicated because a plurality of blocks are layered, and is provided with various program guide information (including title, show times, duration, channel numbers, and the like).

The viewer has access to the same details as in an existing TV guidebook through the EPG on his or her TV in an electronic TV guidebook form.

After having accessed the same details on his or her TV in an electronic TV guidebook form, the viewer can search for and select a desired broadcast.

In this case, there is a disadvantage in that the viewer must perform recording for every program using a program code called a ‘G-code’ to record programs provided by the EGP.

Meanwhile, the IPG is an interactive TV program guide, and displays an operational menu to the viewer in an interactive form so that the operation and manipulation of the latest digital TVs and Personal Video Recorders (PVRs) are facilitated.

In particular, the IPG of the PVR, known as an interactive TV service, is used for service in which the viewer can select and record TV program content, set the viewing age limits, or set reminders.

A general PVR includes a storage device, such as a Hard Disk (HDD), and is a product that stores broadcast analog or digital video streams in real time and subsequently reproduces them.

The PVR is provided with a time shift function enabling the simultaneous storage and reproduction of a broadcast program.

The function allows received broadcast streams to be stored on the HDD, for example, when a viewer receives a telephone call while viewing a current broadcast program, and presses the pause button on the remote controller. Thereafter, when the viewer, having finished the telephone call, presses a play button, scenes following the pause location are reproduced from data that were stored on the HDD. That is, thanks to the time shift function, continuous storage and reproduction are simultaneously performed after a time interval.

Meanwhile, a conventional PVR 1, as shown in FIG. 1, includes a transmission packet decoder 5 for receiving the transport Packet (TP) stream of a broadcast channel, selected by a user, through an antenna 3 and a tuner 4 and parsing the received stream into video and audio streams, a video decoder 7 for receiving and decoding the video stream, parsed by the transmission packet decoder 5, and outputting the decoded result to a display 6, a voice decoder 9 for receiving and decoding the audio stream of the transmission packet decoder 5 and outputting the decoded result to a speaker 8, a storage device 12 for storing a transmission packet stream passed through the transmission packet decoder 5 without parsing it, an image encoder 10 for compressing images decoded by the video decoder 7 and storing compressed images on the storage device 12, an image decoder 11 for receiving the compressed image that has been stored on the storage device 12, decompressing it, and outputting the decompressed result to the video decoder 7, and a control means 2 for controlling the components.

The conventional PVR is characterized in that a story board is supported such that a user can visually grasp details of a program recorded by the PVR recording.

That is, a representative image, which is a portion of the program details stored on the storage device 12 by the image decoder 11, is combined with detailed information about broadcast programs and is then displayed on the display 6 through the video decoder 7, thus constituting a story board.

However, from the point of view of a user using the conventional PVR, the user can only record desired content, which corresponds to guide information, by manipulating the remote controller based on the guide information, such as a newspaper, a guide document, and the EPG, which assume a role of guiding content, such as TV programs and details of channel broadcasts that are currently being shown or are scheduled to be shown.

That is, the user of the PVR can only conduct recording by manipulating the remote controller, keys, and buttons even through EPG and IPG technologies are remarkably developed.

Furthermore, the user of the conventional PVR must personally select and record TV programs, and manage the PVR similar to a general Personal Computer (PC) by deleting unnecessary TV programs in consideration of the capacity of the HDD, even though the functions of the PVR have become convenient to use.

However, a TV is such a passive form that a general person can most conveniently view it by turning it on, and there are few people who further actively conduct recording for later reproducing and viewing.

That is, although an existing VCR also has various functions, and seems to be convenient to use, there are few people who use the functions and record desired programs for viewing.

Furthermore, although, according to the development of a communication network, the user can record TV programs through his or her own PVR or VCR in a remote place, a scheduled recording list can be shown on the user's TV screen, or the scheduled set of a TV program and the search, change, and deletion of a scheduled recording list can be remotely controlled through a remote PC, such things are dependent on the user's manipulation. Accordingly, there is inconvenience in that the user must conduct selection and recording, or fails to record broadcasts due to the user' unskilled manipulation or error.

Furthermore, in relation to the remote control of the PVR, the PVR is remotely controlled through a PC terminal or a data communication terminal to which a network is available, so that the construction of the network is complicated, a corresponding remote control application program must be installed at every place or every terminal from which remote control is desired to be conducted, and remote control is not performed through an easy-to-use general telephone system, therefore, the PVR is inconvenient to use. Furthermore, from the point of view of the operator of a system (service provider), there is a disadvantage in that the maintenance and management of the system are bothersome.

In particular, when the PVR is not connected to an ultra high-speed network, as is a general PC, the conventional PVR cannot process both control signals and data signals for remote control.

### BRIEF DESCRIPTION OF THE DRAWINGS

FIG. 1 is a block diagram illustrating a conventional PVR;

FIG. 2 is a diagram showing the construction of a network for an individual broadcast recording channel service system using XML according to an embodiment of the present invention;

FIG. 3 is a diagram illustrating the structure of PvrXML shown in FIG. 2,

FIG. 4 is a block diagram illustrating the construction of the interior of a PVR shown in FIG. 2;

FIG. 5 is a block diagram illustrating the operational relationships of the PVR shown in FIG. 4; and

FIGS. 6 and 7 are flowcharts illustrating a method of providing an individual broadcast recording channel service using the XML of the present invention.

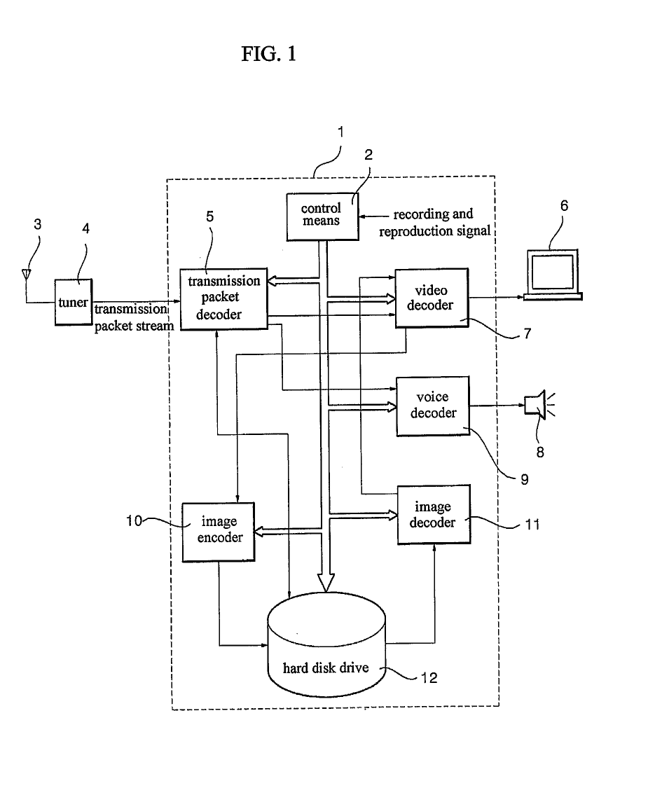

### DISCLOSURE

Technical Problem

Accordingly, the present invention has been made keeping in mind the above problems occurring in the prior art, and an object of the present invention is to provide a system and method for providing personal broadcast recording channel service using XML, which remotely control a remote PVR on a service provider side using PvrXML (tentatively named) that is a type of RCXML (Remote Control XML: tentatively named) newly defined on the basis of XML for remote control service, thus allowing complicated, various, easy-to-miss TV program details to be conveniently recorded and viewed.

Another object of the present invention is to provide a system and method for providing personal broadcast recording channel service using XML, which periodically transmits previously planned recording scenarios in PvrXML format to subscribers' PVRs through a common network, thus recording broadcast programs desired by users.

A further object of the present invention is to provide a system and method for providing personal broadcast recording channel service using XML, which cause the users' PVRs to periodically store broadcast programs on the HDD of the PVR in forms of corresponding content and a recording list according to the recording scenarios, thus enabling the use of a personal program recording channel though the content and the recording list.

Technical Solution

In order to accomplish the above object, the present invention provides a system for providing personal broadcast recording channel service using XML, which provides PVR channel service to a plurality of PVRs over a common network using XML, the system including an interface server coupled to provide a PVR channel service user interface so as to allow a corresponding communication terminal to gain access over the common network, and to control data input and output signals for any one of the entry/use/change/cancellation of the PVR channel service through the interface; and a wizard/transmission server coupled to share an input and stored DataBase (DB) through the interface server; wherein the wizard/transmission server creates personal PvrXML files using the DB and transmits the created files to the PVRs.

In accordance with the present invention, it is preferred that the wizard/transmission server include a PvrXML creation module for creating the PvrXML files and detailed information using the information of the DB; a PvrXML editing module for editing the PvrXML files created by the PvrXML creation module; a PvrXML transmission module for transmitting the PvrXML files to the PVR over the common network; an Identification (ID) code management module for processing ID codes, which correspond to any one of subscriber information, member numbers, caller IDs, the telephone numbers of telephone lines to which the PVRs are connected, member IDs, the Serial Numbers (S/Ns) of the PVRs, and the IP addresses of the PVRs, into data to be used by the PvrXML transmission module, and managing the processed data for individual users.

In accordance with the present invention, it is preferred that the DB be any one of a web DB, a detailed information DB, a member DB, a PvrXML tag language DB, a recording scenario DB, and a service DB that are used to prepare the PvrXML files and the detailed information, and is stored in memory that can be controlled by processors of the interface server and the wizard/transmission server.

In accordance with the present invention, it is preferred that PvrXML tags stored in the PvrXML tag language DB be at least one selected from a PvrXML group consisting of <pvr> </pvr>, tags for starting connection with the PVR; <list> </list>, tags for selecting a recording list; <title> </title>, tags for showing a title of a selected program title; <recordset> </recordset>, tags for setting recording; <attach> </attach>, tags for adding a task; <save> </save>, tags for storing entire settings; <record_list> </record_list>, tags for showing the title of a recorded program; <delete> </delete>, tags for deleting a recorded program; <pvr_completion> </pvr_completion>, tags for finishing all operations.

In accordance with the present invention, it is preferred that the PvrXML creation module parse any portion of data from a service DB, including a recording scenario, a PvrXML tag, and user input data, in PvrXML format using memory and a processor of the wizard/transmission server.

In accordance with the present invention, it is preferred that the interface be installed in the interface server to support web, Wireless Application Protocol (WAP), Automatic Response System (ARS), VoiceXML (VXML), channel broadcast, and power line communication schemes and provide access.

In accordance with the present invention, it is preferred that each of the PVRs include a control unit having at least a stream control function; a Transport packet (TP) interface for inputting a broadcast signal to the control unit on a TP basis; middleware coupled to the control unit to receive control signals configured such that the hardware and software of the PVR are operated by the control unit; and a PvrXML interpreter coupled to the control unit to interpret at least one PvrXML file received over the common network and parse the interpreted PvrXML file into the control signals.

In accordance with the present invention, the PVR further includes an input signal select control unit having electronic circuits or a software algorithm to perform an intermediation operation of selecting either a first operation of checking an input signal received from an input unit coupled to the control unit, and a control signal received from the PvrXML interpreter, and allowing the middleware to operate a corresponding PVR while displaying the operational status of the PVR on a screen, or a second operation of operating the corresponding PVR in the background of a picture according to the recording scenario of the PvrXML file.

The present invention provides a method for providing personal broadcast recording channel service using XML, the method including a server-side process of an interface server performing the step of inputting information about member entry, to a member DB; the step of receiving information about members' recording preferences from member terminals and inputting the received information to a corresponding DB; the step of processing information based on viewers' analyzed tendencies and inputting the processed information to a corresponding DB; the step of extracting keywords from the input information, compiling the index of the extracted keywords, and storing detailed information, which corresponds to the keywords, in a detailed information DB while analyzing the members' recording preferences; the step of a wizard/transmission server preparing recording scenarios based on detailed information related to the analyzed information; the step of creating files in PvrXML format based on the recording scenarios using a PvrXML conversion unit; and the step of transmitting the PvrXML files and the detailed information to corresponding members' PVRs through a common network.

In addition, the present invention provides a method for providing personal broadcast recording channel service using XML, the method including a client-side process of a PvrXML interpreter of each PVR performing the step of receiving a PvrXML file and detailed information, and recording and storing the detailed information on a corresponding storage device (HDD); the step of parsing the details of script document of the PvrXML file into a control signal for either remote recording or channel guide control of the PVR, and inputting the parsed control signal using middleware; and the step of the middleware inputting operational instructions, which corresponds to the input control signal, to a control unit.

In accordance with the present invention, it is preferred that the client-side process further include the step of allowing a menu screen to pop up on a screen of a display device in response to a user's manipulation signal; and the step of allowing a recording list, which corresponds to the recorded and stored information, to be displayed on the menu screen, and allowing detailed information, which includes advertisement, to be further displayed on the menu screen when a user selects each item from the recording list.

In the present invention, the personal broadcast recording channel service using XML, the PVR channel service, and personal broadcast recording proxy service are services based on the same concept.

The services act for a user, capable of using a terminal connected to a common network, and allow a predetermined broadcast program to be recorded in a user's PVR located in a remote place, so that they are services that allow content, which is recorded by proxy recording, to be viewed through a TV channel only for the user.

For example, the PVR channel service is classified into a broadcast channel service scheme that allows broadcast programs to be completely recorded in the users' PVRs according to elaborate scenarios that are planned in advance by a service provider (PVR channel service operator), and a simple remote recording service scheme that allows corresponding broadcast programs to be recorded in users' own PVRs by transmitting the users' decision on desired details to a server through the users' available terminals according to need.

That is, the broadcast channel service scheme records the details of broadcast programs on a second storage device only for channel content, and the simple remote recording service scheme records the details of broadcast programs on a first storage device only for personal content.

The broadcast recording channel service of the present invention may be extended to a control service for home appliances using RCXML, which will be described later. In the description of the best mode described later, functions, components, and service associated with PvrXML may be replaced with functions, components, and service associated with RCML.

That is, the home appliances include refrigerators, washers, boilers, computers, audio systems, TVs, and air conditioners. The broadcast recording channel service of the present invention may be applied to any products used for home automation, and these products must be necessarily provided with predetermined RCXML interpreters similar to the PvrXML interpreters of PVRs.

The user can perform application/entry/use/change/cancellation on the personal broadcast recording channel service using XML through communication technology related to available terminals, that is, wired Internet communication technology, such as a web scheme, mobile communication technology including at least WAP, communication technology using a telephone, voice web or ARS scheme, and bi-directional TV broadcasting technology using Interactive Protocol (IP), and can remotely control home appliances in a similar manner.

Advantageous Effect

In accordance with the present invention, the system and method for providing personal broadcast recording channel service using XML has an advantage in that the PVR can be freely used without limitation even in locations, other than the home.

Furthermore, the system and method for providing personal broadcast recording channel service using XML has an advantage in that the specialized service providing company of the present invention produces control instructions that allow amusing and useful broadcast programs or music to be recorded according to category using a previously well-planned method, and provides them to individuals, even if a user does not personally perform a complicated and difficult procedure to schedule recording, thus providing new service, such as personal PVR channel service, to the user.

In this case, the user can view desired broadcasts using the PVR, similarly to a currently provided, paid VOD broadcast. However, in the case of existing VOD service, a fee must be paid for each program. In contrast, when the present invention is employed, the user simply records and stores TV broadcasts in his or her own PVR and then reproduces the stored TV broadcasts according to the user's manipulation, so that the user can select and view only programs desired by the user from a menu.

Furthermore, the system and method for providing personal broadcast recording channel service using XML has an advantage in that the use thereof is convenient due to various UIs.

Furthermore, the system and method for providing personal broadcast recording channel service using XML can create revenue because banners can be attached to the GUI, including a recording list for reproduction, and is a profit model that can achieve success as a business model using a computer network because a monthly membership fee is collected through premium service.

Best Mode

A preferred embodiment of the present invention is described in detail with reference to the accompanying drawings below.

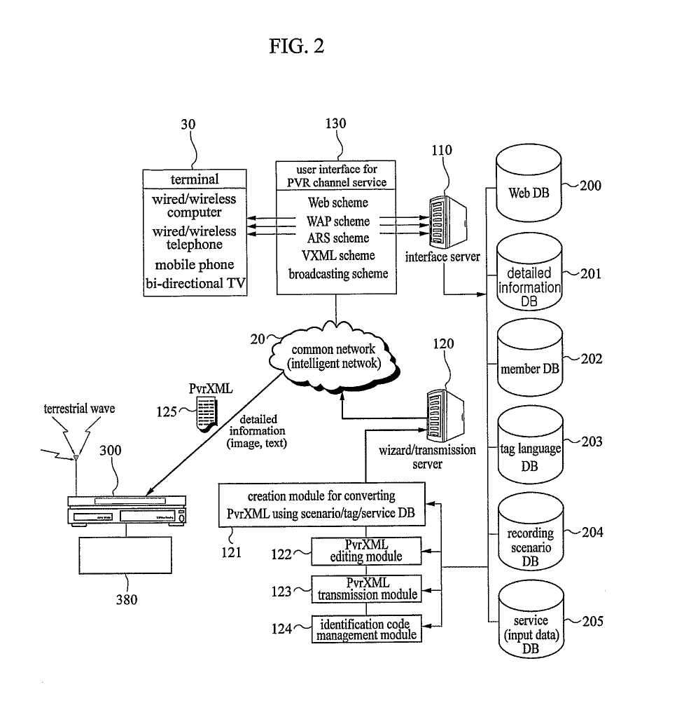

As shown in FIG. 2, the present invention can be applied to a PVR 300, which corresponds to the next generation digital home appliance to replace existing Video Cassette Recorders (VCRs), or to any apparatus similar to the home appliance.

The PVR 300 digitally stores (maintains) and reproduces content on an HDD or a Digital Video Disk (DVD), compresses and reproduces the content according to a Moving Picture Experts Group (MPEG)-2 standard, provides general functions, such as Video On Demand (VOD), Music On Demand (MOD), Pay-Per-View (PPV), an IPG, an EPG, and passive selection schedule recording, and is remotely controlled by a PvrXML file 125 for the PVR channel service of the present invention.

PvrXML is a type of RCXML, and is defined by tags depending on the remote control of the PVR 300.

RCXML has been newly defined as Remote Control XML, and may be applied to all home appliances the remote control of which is performed using a remote controller and wired or wireless communication.

Furthermore, RCXML may be an example of a format, such as ‘oooXML,’ according to the type of corresponding home appliance. For example, RCXML to be applied to the PVR 300 may be called PvrXML, and RCXML to be applied to an air conditioner may be called AirXML in a similar manner.

RCXML, which is an XML-based language that has been widely known as an international standard, is advantageous in that the comprehension and development thereof is easy. Furthermore, RCXML is a text-based markup language and, therefore, the size thereof is small, so that RCXML is very suitable for remote control service through wired or wireless communication.

As an international standard to be used and newly defined in the present invention, the chief details and forms of RCXML standard specification are as follows:

1. Introduction

2. Motivation

3. Concepts and Architecture

3.1 Control Processing

3.2 I/O Processing

3.3 Scripting

3.4 Definitions

3.5 Session Life-Cycle

4. Simple Example

4.1 DVR-ON/OFF

4.2 Airconditioner Control

4.3 PVR-Recording

5. RCXML Tag Listing

6. Document Control Flow and Execution

<RCXML>
<PVR>

<if>, <else>, <elseif>
<fetch>, <goto>
<createXML>
<exit>

<log>

7. Communication Protocol

7.1 Telepony Protocol
<comtel.prepated>
<comtel.started>
<comtel.exit>
<comtel.log>

7.2 TCP/IP Protocol

7.3 CDMA Protocol

7.4 Others

8. Variables and Expressions

<assign>

<var>

<script>

9. Event Handling

<eventprocessor>
<transition>

<move>

<cancel>

<cancel>

10. Operations and Resources

<pvr_on>

<comtel_on>

<set_channel>

<recordset_program>

<list_program>

<title_program>

<attach>

<record_program>

<check_dir>

<check_memory>

<search_channel>

<search_file>

<copy>

<save>

<delete>

<pvr_end>

11. Complex Example.

RCXML is provided inside a corresponding device (product), and allows an RCXML file, which is received from the outside, to be used in an interpreter and a control signal reception card.

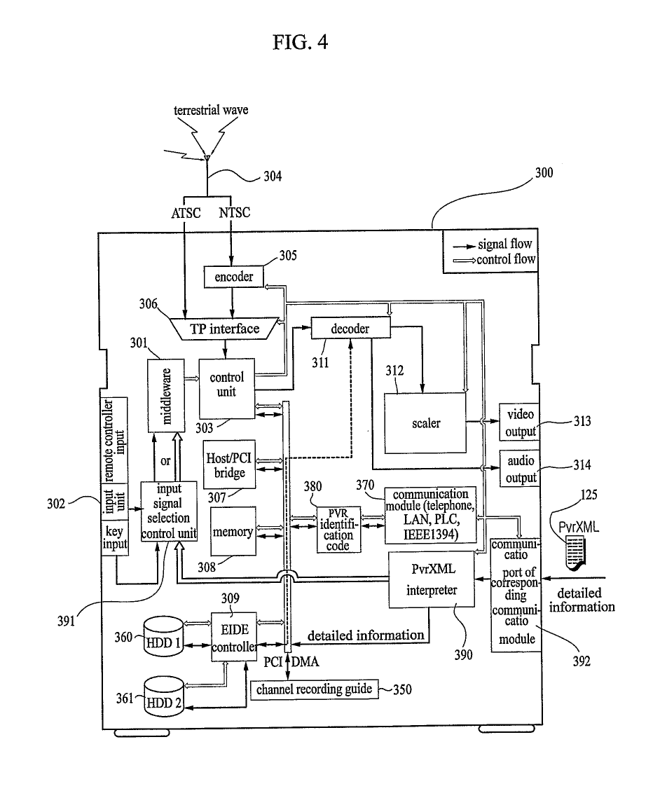

In this case, the control signal reception card has a construction similar or identical to an input signal selection control unit 391, which will be described below (refer to FIG. 4).

That is, the control signal reception card is a device for inputting any one of a control signal from a remote controller, which is provided on a client side, and a control signal, which is interpreted and converted by a corresponding interpreter, to the controller of a corresponding device (home appliance).

Based on remote control technology, such as Remote control (RC) XML, PVR channel service allows broadcast programs, which are desired by a user, or broadcast programs, which are based on a recording scenario made according to the user's preferences forecast by a service provider, to be individually recorded.

For example, a service provider analyzes the preferences of viewers (users) in advance, allows a new program to be recorded daily in the users' PVRs according to content, such as news, drama, sports, or music, and, therefore, the new content is completely recorded through the PVR channel service, similar to a general broadcast channel, so that the users can use the content, which corresponds to recorded and stored broadcast program using digital signal, a recording list, and a channel recording guide.

For this purpose, in the construction of the network of the present invention, a common network 20, including any one of a wired network, a wireless network, a Pubic Switched Telephone Network (PSTN), an intelligence network, a cable TV network, the Internet, a satellite communication network, and a Power Line Communication (PLC) Network, is used.

The common network 20 enables the input of data through wired/wireless communication devices, such as wired/wireless computers, wired/wireless telephones, mobile phones, Personal Digital Assistants (PDAs), and bi-directional TVs, and connects to a terminal 30 so that a predetermined interface screen, which corresponds to the input, can be output.

For example, in the case of the wired/wireless computer terminal, the mobile phone, or the PDA, PVR channel entry, such as service application/entry/use/change/cancellation, is possible after a user connects to the service-providing wired or wireless site of the present invention.

Furthermore, in the case of wired/wireless telephone terminals, the user telephones a service telephone number for the service of the present invention service and performs voice instructions according to a service provider's ARS guidance, thus being capable of using services, such as new member entry, member information change, charging for bill payment, membership cancellation, recording schedule setting, recording schedule list checking, file deletion, and the checking and searching of recorded information list and the details thereof.

Furthermore, in the case of the bi-directional TV, application/entry/cancellation can be performed through an entry window displayed on a TV monitor using a PVR controller (for example, a remote controller, and a hardware/software keypad) based on IP communication.

The server-side construction of the present invention is described below.

It is preferred that the above-described terminal 30 fundamentally use communication service so as to access the common network 20.

In the service provider's server-side system of the present invention, a user interface 130 for the PVR channel service (hereinafter abbreviated as a ‘UI’) is installed in an interface server 110 using general communication technology so as to support web, WAP, ARS, VXML, RCXML, channel broadcasts, and power line communication schemes, and is accessed via the common network 20.

The UI 130 for PVR channel service intermediates the user's and service provider's data, which are input and output to correspond to the communication standards of various terminal devices, between the user terminal 20 and the interface server 110.

For example, the user makes access to a screen for PVR channel service, which employs any one of a template scheme, a simple text list scheme, a GUI selection scheme, and an EPG/IPG scheme in the UI 130, on the screen of a computer/mobile phone/PDA connected to a wired/wireless site, and applies on the service screen to remotely record the program broadcast of a channel desired by a user.

For the remote recording application, the user performs user input processes on remote recording through a PVR channel service menu displayed on the PVR channel service screen of the UI 130.

The user input processes, including, for example, a process of selecting (clicking) a ‘recording button’ adjacent to a desired program name on a schedule provided by the EPG of the present invention, operate in conjunction with PvrXML, that is, a type of RCXML.

Through the process, the user terminal 20 transmits the user's input data to the interface server 110, and the interface server 110, which has received the data, stores the user's history data in any one of databases 200 to 205 described later (hereinafter abbreviated as to “DB”).

Thereafter, the wizard/transmission server 120, which operates in conjunction with the interface server 110, displays resulting pictures, which correspond to the user input processes, on the display window of the terminal 30 through UI 130 using the DBs 200 to 205 and a predetermined template prepared in advance by the service provider.

The resulting pictures, for example, ‘XXX program has been scheduled for recording,’ ‘checking button,’ ‘cancel button,’ ‘upper button,’ and ‘movement to initial picture,’ include hyper text/images or guide text.

That is, the wizard/transmission server 120 is equipped with a wizard engine formed by any one of Hypertext processor (PHP)/Java Server Page (JSP)/Active server Pages (ASP) programming languages, so that it publishes the UI 130 on a predetermined network or enables the input and output of data, which correspond to communication standards or the terminal 30, through the UI 130.

The wizard/transmission server 120 supports a platform, which corresponds to a communication standard, so as to enable access to the common network 20, and operates in conjunction with the interface server 110.

For example, the PvrXML creation module 121 of the wizard/transmission server 120 creates PvrXML files 125 and detailed information by processing the various storage data of the DBs 200 to 205 in response to the input and output signals of the terminal 30, which are input through the interface server 110, and transmits the created results to the user's PVR 300 connected to the common network 20.

The interface server 110 includes memory, in which a predetermined program is stored, similarly to a general web server, and a processor coupled to the memory to execute the program.

The processor of the interface server 110 performs a DB management function, including the storage, indexing, reading, and processing of data, by the program, performs a function of publishing a web document, a WAP document, and an ARS template, and performs a web-based data management function so as to manage the input information as a predetermined DB item.

The wizard/transmission server 120 includes server-side memory, which stores a program for the PvrXML creation module 121 that parses any one of data of the service DB, including a recording scenario, a PvrXML tag, and user input data, in PvrXML format and creates the PvrXML file 125, and processor coupled to the server-side memory to execute the program.

In the wizard/transmission server 120, a PvrXML editing module 122 that can edit the PvrXML file 125 in the same program format is stored in the server-side memory. The PvrXML editing module 122 is programmed such that a function of editing a document, including general XML-based tags, can be provided.

In the wizard/transmission server 120, an ID code management module 124 is stored in the server-side memory. The ID code management module 124, which broadcasts PvrXML files 125 to users' PVRs 300 connected to the common network 20 or individually transmits the PvrXML files 125 to the users's PVRs 300, processes ID codes 380, each of which corresponds to any one of telephone numbers, member IDs, the Serial Numbers (S/Ns) of the PVRs 300, and the IP addresses of the PVRs 300, into data to be used for a PvrXML transmission module 123, and assumes a role of performing management for individual users.

In the wizard/transmission server 120, the PvrXML transmission module 123 is stored in the server-side memory. The PvrXML transmission module 123 performs a function of broadcasting the PvrXML files 125 to the users' PVRs 300, which have the ID codes 380 managed by the ID code management module 124, or of individually transmitting the PvrXML files 125 to the users' PVRs 300.

That is, the wizard/transmission server 120, which is provided with the modules 121 to 124, processes information recorded and stored in the DBs 200 to 205, and creates the PvrXML files 125 using the PvrXML creation module 121.

The created PvrXML files 125 are transmitted to the PVRs 300, respectively, by the PvrXML transmission module 123 and the ID code management module 124, and the PvrXML interpreter of each PVR 300 converts a received PvrXML file 125 into a control signal for middleware.

Furthermore, the PvrXML creation module 121 of the wizard/transmission server is programmed to merge detailed information 120, which has been prepared in advance and stored in a detailed information DB 201, with the converted PvrXML file 125.

In this case, it is preferred that the detailed information is any one of text, images, voices, moving images, data, and the link information thereof.

In the process of merging the detailed information with the PvrXML file 125, advertisement information, advertisement images, and details matched to keywords in the PvrXML file 125 are read out from the detailed information DB 201 by the DB management function of the wizard/transmission server 120, and are then combined with the corresponding PvrXML file 125, so that one transmission data file is obtained.

It is preferred that the wizard/transmission server 120 be operated by its processor, and further include the PvrXML editing module 122 that is stored in memory and can be manually operated by the service provider.

The web DB 200, the detailed information DB 201, the member DB 202, the PvrXML tag language DB 203, the recording scenario DB 204, and the service DB 205 are recorded and stored in the server-side memory that belongs to any one of the interface server 110, the wizard/transmission server 120, and a separate DB server (not shown) coupled to operate in conjunction with each other on a predetermined platform.

In this case, the web DB 200 stores all data and information to be used for Internet access.

The detailed information DB 201, as described above, refers to images, text, voices, and moving image data that correspond to the keywords of details about the PvrXML file to be coupled to the PvrXML file 125. The detailed information DB 201 can be converted into advertisement images, advertisement text, advertisement voices, or advertisement moving images, which represent advertisement desired by an advertiser, according to need, and is visually displayed in a menu, which corresponds to a Graphic User Interface (GUI) that allows the user to select recorded programs, using the PVR 300 of the user, so that advertisement exposure can be achieved for the advertiser, and detailed information can be provided to the user.

The member DB 202 may be details related to all the members, including member names, contact information, addresses, PVR ID code-related information, and telephone numbers.

The PvrXML tag language DB 203 refers to an aggregate in which the definition, structure, item, and type of the above-described PvrXML, and the instruction-related keywords of the recording scenario are recorded and stored.

The recording scenario DB 204 refers to analysis information that is optimally prepared in advance so as to fit the user's preference in consideration of an audience rating index, such as age, sex, style, and viewer popularity ranking, keyword information that the service provider inputs to represent the analysis information, and user input data that the user inputs through the user terminal 30, the common network 20, and the UI 130. The information and the data are recorded and managed for individual users, or are managed according to age, viewer's preference, sex, and job.

The service DB 205, as described above, includes ID codes, schedule and setting time for information necessary for the transmission of the PvrXML files 125, a server-side PVR channel lists according to members, recording time, broadcast types, channels, and titles as well as users' input data input through the user terminal 30.

The structure of the above-described PvrXML is described below.

The structure of the PvrXML is a type of newly defined script language only for the PVR 300, has the remote control XML system of the PVR 300 suitable for a small volume of data, and further includes a device ID code in a header area to identify personal schedule recording and PVR channel service recording.

That is, the system of the PvrXML includes at least one instruction structure that is matched with PVR Application Programming Interface (API), which is capable of controlling the operating system of the PVR 300 or middleware, in a 1:1 manner.

The PvrXML is simple and, at the same time, powerful, so that the handling thereof is possible at anytime and anywhere using a PC or a wireless terminal device using the Internet, and voice instruction is also possible when the PvrXML is linked with VoiceXML (VXML).

Furthermore, the PvrXML has the advantage of XML, so that it has characteristics in that PvrXML tags may be newly defined according to need, and may be added without limitation.

For example, the PvrXML tags include:

1. <pvr> </pvr>: tags for indicating the start and end of PvrXML language,

2. <set_channel> </set_channel>: tags for setting an initial channel,

3. <recordset_program> </recordset_program>: tags for scheduling a program

4. <record_program> </record_program>: tags for recording a program,

5. <attach> </attach>: tags for adding a task,

6. <attach> </attach>: tags for storing entire setting.

7. <check_memory> </check_memory>: tags for checking storage capacity,

8. <search_file> </search_file>: tags for searching for a file

9. <delete> </delete>: tags for deleting a recorded program, and

10. <pvr_completion> </pvr_completion>: tags for finishing all operations.

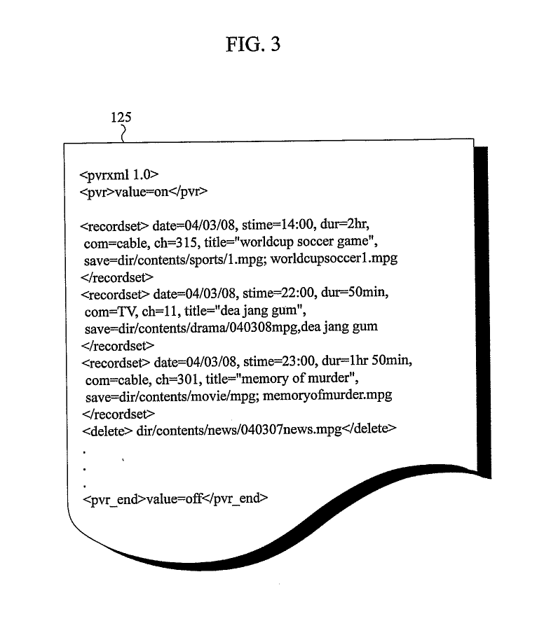

As shown in FIG. 3, the meaning of the PvrXML will be understood through the PvrXML file 125 defined as an example.

Referring to FIG. 3, a PvrXML conversion unit fetches corresponding recording scenario information from the recording scenario DB according to a series of recording scenario preparation start instructions that correspond to the PvrXML preparation of the processor of the wizard/transmission server.

For example, recording scenario information to be stored in the recording scenario DB may include a script document as follows:

“\textcircled{1} declare the version of PvrXML,

\textcircled{2} operate PVR,

\textcircled{3} record cable channel 315 for two hours from Mar. 8, 2004—14:00, and store as ‘040308worldcupsoccer.mpg’ along with the title, ‘World cup Soccer’ to the sports storage folder of a storage device (dir/contents/sports/),

\textcircled{4} record TV channel 11 for 50 minutes from Mar. 8, 2004—22:00, and store as ‘040308deajangkum.mpg’ along with the title, ‘Dea Jang Kum’ to the drama store folder of the storage device (dir/contents/drama/),

\textcircled{5} record cable channel 301 for one hour and fifty minutes from Mar. 8, 2004—23:00, and store as ‘memoryofmurder.mpg’ along with the title, ‘Memory of Murder’ to the movie storage folder of the storage device (dir/contents/movie/),

\textcircled{6} delete ‘040307news.mpg’ file from the news storage folder of the storage device (dir/contents/news/),

\textcircled{7} stop PVR.”

In this case, as shown in FIG. 3, the PvrXML conversion unit compares and checks the keywords of the recording scenario DB and the keywords of the PvrXML tag language DB in a 1:1 manner, and prepares the PvrXML file 125 with respect to a part matched between keywords according to a script document form.

For example, the PvrXML conversion unit reads “<pvr> </pvr>” and “value=on” corresponding to “PVR” and “operation”, respectively, from keywords corresponding to “\textcircled{2} operate PVR,” and then parses the read-out result into a script document form, thus preparing a phrase called “<pvr>value=on</pvr>”.

When the process is repeated, the entire PvrXML file 125 is prepared as shown in FIG. 3.

The client-side construction of the present invention is described below.

As shown in FIG. 4, the PVR 300 further includes a PvrXML interpreter 390, an input signal selection control unit 391 and a communication port 392 along with general PVR hardware and software.

The communication port 392 is coupled with a communication module 370 that supports any one of telephone, Local Area Network (LAN), Power Line Communication (PLC), and IEEE1394 communication standards.

When the communication module 370 performs a PVR identification process on the server side of the service provider through the common network using PVR ID code 380 recorded in memory or PVR BIOS, the communication module 370 transmits the ID code 380 to the server of the service provider (wizard/transmission server). Accordingly, when the server of the service provider transmits the PvrXML file 125 to the corresponding PVR 300, the communication module 370 performs a general process of setting a data transmission path using the ID code 380.

A channel recording guide 350 is installed in the memory 308 of the PVR 300 or any one of first and second storage devices 360 and 361 in a predetermined firmware form, thus assuming a role of indicating content and the items of a recording list recorded in the PVR channel service.

It is preferred that the channel recording guide 350 replace a story board, an IPG, or an EPG provided by an existing PVR, or be linked to it.

The PvrXML interpreter 390, which corresponds to a PvrXML parser engine or a PvrXML interpreter engine and also corresponds to the API standard of a specific PVR 300 or general purpose API standard, receives and interprets the PvrXML file 125 through the communication port 392, and parses details of the PvrXML file 125 into a corresponding middleware control signal or a control signal having a firmware API form.

Thereafter, a control signal output from the PvrXML interpreter 390 is input to the middleware 301 through the input signal selection control unit 391.

The input signal selection control unit 391 has electronic circuits or a software algorithm to perform an intermediation operation of selecting either a first operation of checking an input signal received from an input unit 302 coupled to the control unit 303, and a control signal received from the PvrXML interpreter 390, and allowing the middleware 301 to operate a corresponding PVR 300 while displaying operational status of the PVR 300 on a screen, or a second operation of operating the corresponding PVR 300 in a background of a picture according to the recording scenario of the PvrXML file 125.

The first storage device 360, which is used for personal content only, records and stores broadcast programs using the PvrXML file 125 created to correspond to input data that the user input through the UI of the common network.

The second storage device 361, which is used for channel content only, records and stores broadcast programs using the PvrXML file 125 that the service provider one-sidedly creates.

As describe above, the reason that predetermined content can be recorded and stored on the first and second storage devices 360 and 361 so as to be identified, is because a device ID code, which is capable of identifying whether the content is for a channel or for an individual, is included in the header area of the PvrXML file 125.

That is, the PvrXML interpreter 390 interprets the device ID code, and requests whether to record the content in the first or second storage device 360 or 361 to the control unit 303.

In the case of a general PVR operation method, a display device, which is connected to the PVR 300, corresponds to a scheduled recording procedure through the user's input unit 302 and displays a corresponding menu, or confirming indication after instructions input, on the display screen in an interactive GUI format and in a transparently or opaquely overlaid manner.

Meanwhile, in the case of the recording scenario of the PvrXML file 125, the display device, which is connected to the PVR 300, does not display each recording scenario on the display screen, but displays at least an icon on the display screen and, thereby, informs the user that the PVR 300 is operating according to the recording scenario.

In the present invention, it is preferred that the input signal selection control unit 391 be constructed such that the user can manipulate the PVR 300 and, thereby, the operation according to the recording scenario can be controlled by stopping, pausing, canceling or the like.

The middleware 301 assumes a role of inputting various instructions to the control unit 303 to be performed by the control unit 303.

The PVR 300 receives a terrestrial wave, in Advanced Television System Committee (ATSC) format corresponding to an American type digital broadcast signal standard or National Television System Committee (NTSC) format corresponding to an American type analog broadcast signal standard, through the antenna 304. The present invention can adopt all broadcast signal standards without influencing the PvrXML interpreter 390 merely by changing the hardware of the PVR 300 so as to correspond to Europe type digital and analog broadcast signal standards.

The terrestrial wave may be understood as a Transport Packet (TP) that is a data unit for transmitting general digital or digitalized images.

It can be ascertained that the TP is headed in two directions.

First, when the TP is NTSC, a preprocessing process of producing digital images using the MPEG-2 encoder 305 is necessary. That is, the structure of the TP is identical to that of the broadcast signal standard of a general digital TV through the MPEG-2 encoder 305 assuming transmission packet control. Thereafter, the TP is passed through the TP interface 306 and the control unit 303 having at least a stream control function, an image and voice decoder 311, a video scalar 312, and video/audio output terminals 313 and 314, so that the user can view analog broadcasts, which are currently being broadcast, through the display device (for example, a TV and a monitor) or the speaker connected so as to correspond to the output terminals 313 and 314.

Furthermore, when the TP is ATSC, the TP is directly input to the TP interface 306, and is passed through a HOST/PCI 307, the memory 308, and an EIDE controller 309, and may then be stored on the first and second storage devices 360 and 361, or on DVD-Read Only Memory (ROM) (not shown) in data format.

In the PVR 300, the process of storing the TP in the first and second storage device 360 and 361 is a process of recording a program.

In contrast, a process of reproducing a recorded program is as follows. That is, program data stored on the first and second storage device 360 and 361 are uploaded to the control unit 303 through the memory 308 on a TP basis, and the uploaded program data are output to the image and voice decoder 311, the video scalar 312, the video/audio output terminals 313 and 314, the display device, or the speaker.

However, a user may, for example, come into a home and desires to view a program, which is being currently recorded, from the beginning while the PVR 300 is recording a scheduled program.

A general process of reproducing a program may enable reproduction after the above-described program data have completely been stored on both the first and second storage device 360 and 361, or may be performed by a time shift function that enables the simultaneous storage and reproduction of a broadcast program that is being currently viewed.

The conventional PVR does not have a function of simultaneously performing reproducing and recording, unlike the PVR 300 of the present invention.

Accordingly, the user must wait until the recording of a corresponding program has finished and then perform reproduction from the beginning to view the recorded program, or must perform reproduction on part of a recorded file, which corresponds to an unviewed portion, to view it after stopping recording and viewing current live broadcasting from the time when the recording is stopped.

However, in the case in which the PVR 300 according to the present invention performs reproduction while recording a predetermined program, the PVR 300 includes a reproducing-while-recording function of continuously recording details currently being broadcast into a separate file while reproducing an already recorded portion from the beginning.

That is, the PVR 300 according to the present invention enables reproducing-while-recoding using a kind of time shift.

The reproducing-while-recording is described from a technical point of view. When a reproduction button is pressed for reproduction while recording a certain program, a portion recorded until now is stored on any one of the first and second storage device 360 and 361 through a filename ‘No.1.xxx’ temporarily and automatically granted by the control unit 303 and, at the same time, is transferred to the reproduction area of the memory 308 and reproduced.

Furthermore, based on a time point identical to the automatically granted time point, the program details after storing are continuously recorded through a temporarily and automatically granted filename ‘No.2.xxx’.

In the case in which the reproduction of a ‘No.2.xxx’ file has been completed at the time when the reproduction of a ‘No.1.xxx’ file has finished, the control unit 303 allows the ‘No.2.xxx’ file to be transferred to the reproduction area and reproduced with the reproduction completion of the No.1.xxx file and, therefore, the user can view the program that is continuously being recorded or has been recorded without the interruption of pictures.

Meanwhile, the control unit 303 determines whether the ‘No.2.xxx file is still being recorded upon the completion of the ‘No.1.xxx’ file.

In this case, the time necessary for the determination is so short that the user cannot sense and identify it because the determination is performed by the electronic circuits of the PVR 300. Meanwhile, the problems of picture interruption, time delay, and the like can be solved when the cache memory of the memory 308 is used.

When the simultaneous recording and reproduction function of the PVR 300 is used, the case that the ‘No.2.xxx’ file is still being recorded at the time of completion of the ‘No.1.xxx file may occur under the determination of the control unit 303.

In this case, the control unit 303 stores the ‘No.2.xxx’ file recorded until the reproduction completion time of the ‘No.1.xxx’ file to any one of the first and second storage device 360 and 361 and, at the same time, performs recording on the remaining portion of the program while temporarily and automatically granting a separate filename ‘No.3.xxx’.

In this case, the control unit 303 transfers a ‘No.2.xxx’ file to the reproduction area of any one of the first and second storage device 360 and 361 at the completion time of a ‘No.1.xxx’ file and reproduces it.

The file grant of the control unit 303 is continuously performed in the same manner as described above until recording is finished.

When the reproduction of a final file is completed among the divided, stored files, the control unit 303 stores all the divided, stored files as a single file.

The operation method of the present invention is described based on the operation of the PVR 300 below.

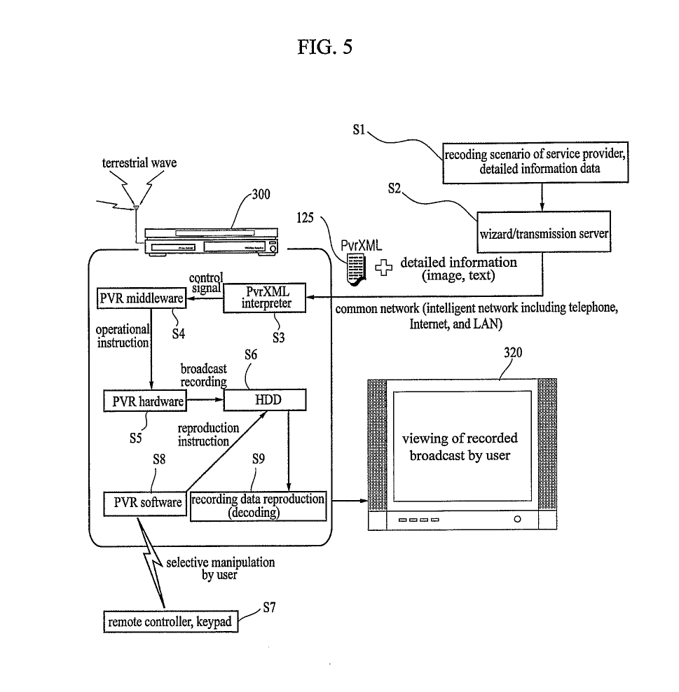

As shown in FIG. 5, in the server side, a service provider's recording scenario and detailed information are prepared as transmission data at step S1.

Thereafter, the prepared transmission data are converted into a PvrXML file 125 and the detailed information by any one of the wizard/transmission server, including at least one PvrXML conversion unit, or the interface server, and the detailed information is combined with the PvrXML file 125, at step S2.

The PvrXML file 125 with which the detailed information is combined is transmitted to the PVR 300 of an individual, who becomes a member of the broadcast recording service of the present invention, through the common network including a telephone, the Internet, and a LAN.

The PvrXML interpreter of the PVR 300 divides the PvrXML file 125 into PvrXML script and detailed information. The PvrXML interpreter of the PVR 300 interprets the PvrXML script document, parses it into a middleware control signal, and records and stores the detailed information on a storage device (the storage device at least include memory, or a HDD), at step S3.

The Middleware of the PVR 300 directs the hardware of the interior of a corresponding PVR to an operation instruction based on a series of a control signal input from the PvrXML interpreter, at step S5.

Accordingly, the hardware, to which the operation instruction is directed, performs an operation, such as broadcast recording, thus storing details of TV programs on the HDD or a DVD-ROM in a data format, at step S6.

Thereafter, the user manipulates the buttons of a remote controller or a keypad and, thereby, the user's selective manipulation signal, such as PVR reproduction, is input into the input unit of PVR 300, at step S7.

In this case, reproduction instruction is input to the control unit of the PVR 300 by the middleware of the PVR 300, or an operation algorithm having the a software format or the API of firmware, which is stored in the memory, at step S8.

The control unit of the PVR 300 decodes data that have been recorded and stored on a plurality of storage devices or a DVD-ROM, and displays the decoded data on the display device 320, such as the user's TV and monitor, at step S9.

A method for providing personal broadcast recording channel service using the above-describe XML is described with the help of a server-side flowchart and a client-side flowchart.

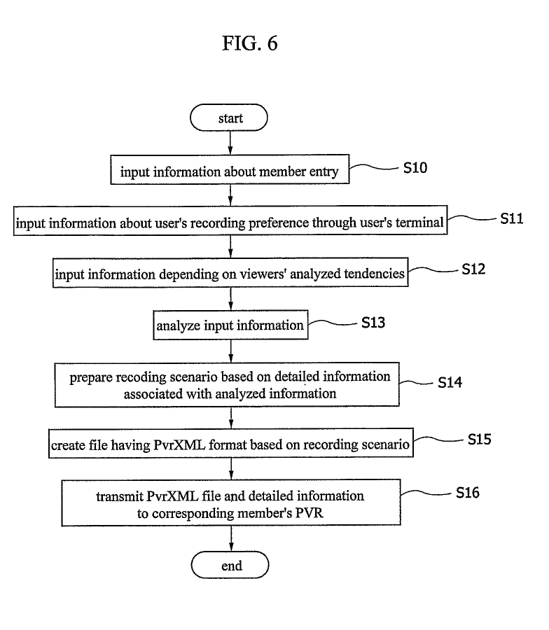

As shown in FIG. 6, on the server side, the interface server allows an interface server to perform the step S10 of inputting information about member entry, to a member DB, the step S11 of receiving information about members' recording preferences from member terminals and inputting the received information to a corresponding DB, the step S12 of processing information based on viewers' analyzed tendencies and inputting the processed information to a corresponding DB, the step S13 of extracting keywords from the input information, compiling an index of the extracted keywords, and storing detailed information, which corresponds to the keywords, in a detailed information DB while analyzing the members' recording preferences, the step S14 of a wizard/transmission server preparing recording scenarios based on detailed information related to the analyzed information, the step S15 of creating files in PvrXML format based on the recording scenarios using a PvrXML conversion unit, and the step S16 of transmitting the PvrXML files and the detailed information to corresponding members' PVRs through a common network.

The step S11 of the interface server receiving information about member recording preferences from members' terminals and inputting the received information to a corresponding DB is a step of using the service of the present invention through terminals and UIs that the are available by users, and is described, in detail, below for 1) a wired/wireless Internet/bi-directional TV scheme, 2) a mobile scheme, 3) an ARS/VXML scheme, and 4) a channel broadcast scheme.

1) The Wired/Wireless Internet/Bi-Directional TV Scheme

In the UI using web, WAP, IP, and power line communication, the web page of a PVR channel portal site, having a HTML format, is displayed on the window of a computer, a PDA, a mobile communication terminal, a mobile phone, or a bi-directional TV display (monitor), and a user (service user, member) accesses the EPG of the web page after member authentification. That is, the user manipulates any one of the mouse, keyboard, touch screen, stylus, and remote controller of a corresponding terminal, thus selecting a broadcast program title in a broadcast program list on the EPG.

In this case, the terminal transmits input data, which correspond to the selected details, to the service provider-side server (interface server or wizard/transmission server) through the UI.

The service provider-side server records and manages the received input data to a DB and, at the same time, shows a recording scheduled scenario list on the display window of a user terminal display using the input data in a template form.

The service provider-side server receives signals resulting from processes of the user's changing and checking the recording scheduled scenario signal.

Thereafter, the service provider-side server creates a PvrXML file based on the recording scheduled scenario using the PvrXML creation module, and transmits the PvrXML file to the user's PVR using the PvrXML transmission module.

Furthermore, in an Internet wired site or a bi-directional TV, the user can further variously select broadcast programs (channel) to be recorded while viewing a preview, the description of details.

Furthermore, similarly to a wireless site, the recording of a desired channel can be scheduled as a PVR channel is selected on the screen of a mobile phone/PDA screen.

2) The Mobile Scheme

For example, a procedure of using WAP is described. A main menu called “TV recording” pops up on the screen of a mobile phone screen, and a sub menu called “1. Dramas, 2. News, 3. Movie, 4. Amusement” pops up on the screen. The user uses the keypad buttons of the terminal, and the user can enter into the drama sub menu when “1” is pressed. In the drama sub menu, the titles, “1. Flame, 2. Snow White, 3. Dea Jang Kum, 4. Others” is displayed. Accordingly, the user presses the keypad buttons according to a display order and performs Dual Tone MultiFrequency (DTMF) input, so that user the input data, which correspond to the recording scheduled scenario, are transmitted to the service provider-side server and the PvrXML file is transmitted to the user's PVR according to the same procedure.

3) The ARS/VXML Scheme

For upper interactive language conveniently used through ARS telephone (DTMF input), or wired and wireless service sites, a scheme of inputting individual instructions, or a scheme of copying a well-made PvrXML file and sending it to the user's PVR through a wizard/transmission server is available. In the case of the ARS telephone, the service of the present invention can be provided similarly to a bell sound type or a coloring service type. Example:

Interface server: “Hello, member OOO, Here is a PVR channel. Today, world cup soccer recording is No. 0, drama recording No. 1, news recording No. 2, and movie No. 3, . . . ,”

Member: pressing No. 1, or saying “No. 1” using voice

Interface server: “Flame No. 1 in the drama recording, Snow white No. 2, . . . ”

Member: pressing No. 1, or saying “No. 1” using voice

Interface server: “recording Flame, a MBC serial drama, Apr. 26, 2004. Please, press a button, confirm No. 1, Cancel No. 2.”

In such a manner, the service in which a user (member) selects a desired program and conducts recording will create profit in paid ARS fashion. In this case, data are updated daily and scenarios are updated, so that VXML is more useful than an existing ARS. It is preferred to use TTS rather than to prepare the details of recording type ARS.

4) The Channel Broadcast Scheme

In this scheme, there is no particular need to access a certain terminal for recording, other than the user's member entry for the service of the present invention. This is because a service provider can create PvrXML files based on previously planned scenarios.

From the above-described scheme, the service provider collects a monthly fixed fee or a fee per case, similar to a bell sound or coloring service.

Furthermore, once the PvrXML file is created, the PvrXML file is transmitted to the member's personal PVR and is automatically recorded.

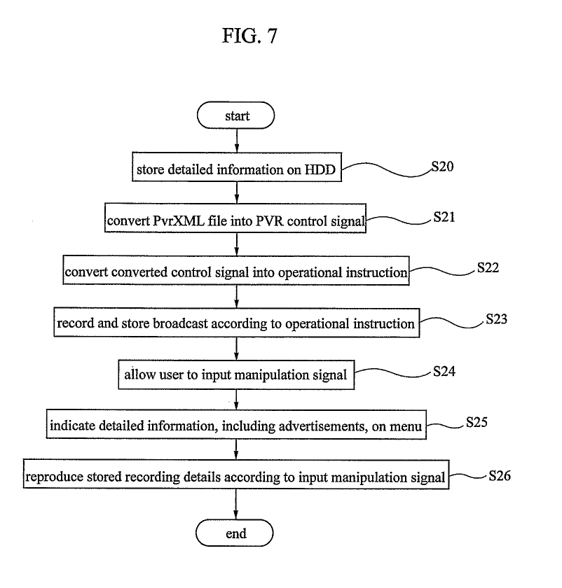

That is, as shown in FIG. 7, on the client-side, the step S20 of receiving a PvrXML file and detailed information, and recording and storing the detailed information on a corresponding storage device (HDD), the step S21 of parsing details of script document of the PvrXML file into a control signal for either remote recording or channel guide control of the PVR, and inputting the parsed control signal using middleware, and the step S22 of the middleware inputting operational instructions, which corresponds to the input control signal, to a control unit, the step S23 of the control unit recording and storing TV broadcasting programs according to the operation instructions, the step S24 of inputting a user's manipulation signal to an input unit and allowing a menu screen to pop up on a screen of a display device menu screen, the step S25 of allowing a recording list, which corresponds to the recorded and stored information, to be displayed on the menu screen and allowing detailed information, including advertisement, to be displayed on the menu screen, when a user selects individual items for the recording list, and the step S26 of reproducing recording details, which corresponds to the selected items, are performed by the PvrXML interpreter of a PVR.

A process after the step S24 of allowing the menu screen to pop up is described. The PVR of the present invention is provided with a communication port that can access the Internet, so that a banner picture file or a flash file (*.swf) along with simple text-based instruction data is included in the PvrXML file and is transmitted, or a tag value, which can call a Uniform Resource Locator (URL) in which a corresponding file is stored, may be transmitted.

In this case, an icon or a picture (for example, a “Dea Jang Kum mark”), which indicates recorded details or content, or a banner is displayed on the menu screen of middleware, so that a further menu screen can be viewed.

In this case, various menu screens can be displayed on the menu screen compared to the conventional PVR in which the image encoder is provided in the PVR itself and, thereby, the story board is implemented

For example, “Silmi island” is indicated in the recorded movie menu and a silmi island advertisement is attached to the menu, so that the Silmi island advertisement picture can be displayed along with the description of details of the recording list.

The construction of the PvrXML tag of the present invention for managing the recording list is as follows.

It is possible to extend the attributes of a tag, such as “<recordset> title=“silmiisland”, attach=“silmiislandbanner.jpg”, attach=“silmiislandadvertisement.swf”>.”

When the function is employed, a profit model, that is, a banner, in which the broadcast recording service of the present invention can be freely provided, becomes possible.

That is, banners provided in real time are attached to the upper end of the recording list or the search menu, so that it is not necessary for the user to separately pay a monthly fixed fee or monthly dues for the use of the service of the present invention, and premium service, which is so elaborate, convenient, and abundant that monthly dues are paid, can be provided to a user by discriminating the quality of VOD, MOD, and recording scenarios.

In particular, the PVR separately manages the first and second storage devices. That is, in the first storage device, recording content and a recording list, which are set by an individual, are recorded and managed. In contrast, in the second storage device, recording content and a recording list set by the service provider are recorded and managed.

Although the preferred embodiments of the present invention have been disclosed for illustrative purposes, those skilled in the art will appreciate that various modifications, and substitutions are possible, without departing from the scope and spirit of the invention as disclosed in the accompanying claims.

1. A system for providing personal broadcast recording channel service using extensible Markup Language (XML), which provides Personal Video Recorder (PVR) channel service to a plurality of PVRs (300) over a common network (20) using XML, the system comprising:
an interface server (110) coupled to provide a PVR channel service user interface (130) so as to allow a corresponding communication terminal (30) to gain access over the common network (20), and to control data input and output signals for any one of the entry/use/change/cancellation of the PVR channel service through the interface (130); and a wizard/transmission server (120) coupled to share an input and stored DataBase (DB) through the interface server (110); wherein the wizard/transmission server (120) creates personal PvrXML files (125) using the DB and transmits the created files to the PVRs (300).

2. The system according to claim 1, wherein the wizard/transmission server (120) comprises:
a PvrXML creation module (121) for creating the PvrXML files (125) and detailed information using information of the DB; a PvrXML editing module (122) for editing the PvrXML files created by the PvrXML creation module; a PvrXML transmission module (123) for transmitting the PvrXML files (125) to the PVR (300) over the common network; an Identification (ID) code management module (124) for processing ID codes (380), which correspond to any one of subscriber information, member numbers, caller IDs, telephone numbers of telephone lines to which the PVRs (300) are connected, member IDs, Serial Numbers (S/Ns) of the PVRs (300), and IP addresses of the PVRs (300), into data to be used by the PvrXML transmission module (123), and managing the processed data for individual users.

3. The system according to claim 1, wherein the DB is any one of a web DB (200), a detailed information DB (201), a member DB (202), a PvrXML tag language DB (203), a recording scenario DB (204), and a service DB (205) that are used to prepare the PvrXML files and the detailed information, and is stored in memory that can be controlled by processors of the interface server (110) and the wizard/transmission server (120).

4. The system according to claim 3, wherein PvrXML tags stored in the PvrXML tag language DB (203) are at least one selected from a PvrXML group consisting of <pvr> </pvr>, tags for starting connection with the PVR; <list> </list>, tags for selecting a recording list; <title> </title>, tags for showing a title of a selected program title; <recordset> </recordset>, tags for setting recording; <attach> </attach>, tags for adding a task; <save> </save>, tags for storing entire settings; <record_list> </record_list>, tags for showing a title of a recorded program; <delete> </delete>, tags for deleting a recorded program; <pvr_completion> </pvr_completion>, tags for finishing all operations.

5. The system according to claim 1, wherein the PvrXML creation module (121) parses any portion of data from a service DB, including a recording scenario, a PvrXML tag, and user input data, in PvrXML format using memory and a processor of the wizard/transmission server (120).

6. The system according to claim 1, wherein the interface (130) is installed in the interface server (110) to support web, Wireless Application Protocol (WAP), Automatic Response System (ARS), VoiceXML (VXML), channel broadcast, and power line communication schemes and provide access.

7. The system according to claim 1, wherein each of the PVRs (300) comprises:
a control unit (303) having at least a stream control function; a Transmission Packet (TP) interface (306) for inputting a broadcast signal to the control unit (303) on a Transport Packet (TP) basis; middleware (301) coupled to the control unit (303a) to receive control signals configured such that hardware and software of the PVR (300) are operated by the control unit (303); and a PvrXML interpreter (390) coupled to the control unit (303) to interpret at least one PvrXML file (125) received over the common network (20) and parse the interpreted PvrXML file into the control signals.

8. The system according to claim 7, wherein the PVR (300) further comprises an input signal select control unit (391) having electronic circuits or a software algorithm to perform an intermediation operation of selecting either a first operation of checking an input signal received from an input unit (302) coupled to the control unit (303), and a control signal received from the PvrXML interpreter (390), and allowing the middleware (301) to operate a corresponding PVR (300) while displaying operational status of the PVR (300) on a screen, or a second operation of operating the corresponding PVR (300) in a background of a picture according to the recording scenario of the PvrXML file (125).

9. A method for providing personal broadcast recording channel service using XML, the method comprising a server-side process of an interface server performing:
the step (S10) of inputting information about member entry, to a member DB; the step (S11) of receiving information about members' recording preferences from member terminals and inputting the received information to a corresponding DB; the step (S12) of processing information based on viewers' analyzed tendencies and inputting the processed information to a corresponding DB; the step (S13) of extracting keywords from the input information, compiling an index of the extracted keywords, and storing detailed information, that corresponds to the keywords, in a detailed information DB while analyzing the members' recording preferences; the step (S14) of a wizard/transmission server preparing recording scenarios based on detailed information related to the analyzed information; the step (S15) of creating files in PvrXML format based on the recording scenarios using a PvrXML conversion unit; and the step (S16) of transmitting the PvrXML files and the detailed information to corresponding members' PVRs through a common network.

10. A method for providing personal broadcast recording channel service using XML, the method comprising a client-side process of a PvrXML interpreter of each PVR performing:
the step (S20) of receiving a PvrXML file and detailed information, and recording and storing the detailed information on a corresponding storage device (HDD); the step (S21) of parsing details of script document of the PvrXML file into a control signal for either remote recording or channel guide control of the PVR, and inputting the parsed control signal using middleware; and the step (S22) of the middleware inputting operational instructions, which corresponds to the input control signal, to a control unit.

11. The method according to claim 10, wherein the client-side process further comprises:
the step (S24) of allowing a menu screen to pop up on a screen of a display device in response to a user's manipulation signal; and the step (S25) of allowing a recording list, which corresponds to the recorded and stored information, to be displayed on the menu screen, and allowing detailed information, which includes advertisement, to be further displayed on the menu screen when a user selects each item from the recording list.
